(19) United States
(12) Patent Application Publication
(10) Pub. No.: US 2017/0205904 A1
(43) Pub. Date: Jul. 20, 2017

(54) REMOTE CONTROLLER WITH JOG SHUTTLE AND METHOD OF USING THE SAME TO CONTROL MENU SETTINGS FOR ELECTRONIC APPARATUS

(71) Applicant: SAMSUNG ELECTRONICS CO., LTD., Suwon-si (KR)

(72) Inventors: Yui-yoon LEE, Suwon-si (KR); Dae-yeon YUN, Seoul (KR); Su-hwan JIN, Suwon-si (KR)

(73) Assignee: SAMSUNG ELECTRONICS CO., LTD., Suwon-si (KR)

(21) Appl. No.: 15/405,583

(22) Filed: Jan. 13, 2017

(30) Foreign Application Priority Data
Jan. 15, 2016 (KR) 10-2016-0005479

(51) Int. Cl. G06F 3/0362; G06F 3/0487; G06F 3/0482

(52) U.S. Cl. CPC G06F 3/0362; G06F 3/0482; G06F 3/0487; H04N 5/44543

(57) ABSTRACT

A method of controlling a remote controller comprising a jog shuttle that provides a first control of moving a control knob along a plate surface of the remote controller and a second control of turning the control knob. The method includes transmitting, to an electronic apparatus, a display command of displaying a setting menu screen for the electronic apparatus on a display of the electronic apparatus in response to one of the first control and the second control being performed; and transmitting, to the electronic apparatus, a moving command of moving a cursor pointing to one of menus displayed on the menu screen in response to the other one of the first control and the second control being performed.

### CROSS-REFERENCE TO RELATED APPLICATION

The application claims priority from Korean Patent Application No. 10-2016-0005479 filed on Jan. 15, 2016 in the Korean Intellectual Property Office, the disclosure of which is incorporated herein by reference in its entirety.

### BACKGROUND

Field

Apparatuses and methods consistent with the exemplary embodiments relate to a remote controller with a jog shuttle and a method of using the same to control menu settings for an electronic apparatus, and more particularly, to a method of using the jog shuttle to display and select a menu of an electronic apparatus desired by a user.

Description of the Related Art

A remote controller is a device provided for allowing a user to easily control operations of an electronic apparatus. The remote controller includes control buttons such as numeric keys and various function keys. Among the remote controllers, there is a remote controller with a jog shuttle. The jog shuttle includes a control knob to be turned by a user and offers functions for performing desired operations as the control knob is turned.

Typically, the jog shuttle provides functions for controlling a screen currently displayed on a television (TV) or the like image display device. Representatively, the control function is to increase a playback speed of a moving image being currently played back or to run the moving image backward in order to view a previously played part again. Such a typical function is suitable for playing back a moving image stored in a recording medium on the TV.

Alternatively, the jog shuttle may have another function in addition to the foregoing typical functions. For example, the jog shuttle may be assigned to volume control since the jog shutter is suitable for turning operation according to a user's intuition and the tuning operation is frequently used in controlling volume of an image being played back.

By the way, such a conventional remote controller with the jog shuttle has been used only for direct control about playback methods of an image being currently played back. This means that the jog shuttle has been restrictively used even though it is very versatile. Accordingly, there is a need of utilizing the jog shuttle in a more flexible manner and in various ways in order to make the remote controller more convenient for a user.

In addition, the remote controller needs supply of power for operation and generally uses a replaceable battery as a power source. Besides, the remote controller has been developed to have a rechargeable battery without the need of replacing the battery. In this case, the remote controller having the rechargeable battery generally employs a photovoltaic system. However, the remote controller is mostly used indoors, and indoor light is likely to be insufficient to cover power consumption of the remote controller.

### SUMMARY

In accordance with an exemplary embodiment, there is provided a method of controlling a remote controller comprising a jog shuttle that provides first control of moving a control knob along a plate surface of the remote controller and second control of turning the control knob, the method comprising: transmitting, to an electronic apparatus, a display command of displaying a menu screen for setting the electronic apparatus on a display of the electronic apparatus as one of the first control and the second control is performed; and transmitting, to the electronic apparatus, a moving command of moving a cursor pointing one of menus displayed on the menu screen as the other one of the first control and the second control is performed.

The display command may correspond to the first control, and the moving command may correspond to the second control.

The jog shuttle may provide third control of pressing the control knob toward the plate surface of the remote controller, and the method may further comprise transmitting, to the electronic apparatus, a selection command of selecting the menu pointed by the cursor as the third control is performed.

The remote controller may comprise a switch for switching between a first mode where the jog shuttle is used in controlling an operation of the electronic apparatus and a second mode where the jog shuttle is used in controlling a menu settings of the electronic apparatus, and the display command or the moving command corresponding to the first control or the second control may be transmitted in the second mode.

In accordance with another exemplary embodiment, there is provided a method of controlling an electronic apparatus according to a command from a remote controller with a jog shuttle that provides first control of moving a control knob along a plate surface of the remote controller and second control of turning the control knob, the method comprising: recognizing a command, which is input as one of the first control and the second control is performed, as a display command, and displaying a menu screen for setting the electronic apparatus on a display of the electronic apparatus; and recognizing a command, which is input as the other one of the first control and the second control is performed, as a moving command, and moving a cursor pointing one of menus displayed on the menu screen.

The display command may correspond to the first control, and the moving command may correspond to the second control.

The jog shuttle may provide third control of pressing the control knob toward the plate surface of the remote controller, and the method may further comprise recognizing a command, which is input as the third control is performed, as a selection command, and selecting the menu pointed by the cursor.

The electronic apparatus may have a first mode where the jog shuttle is used in controlling an operation of the electronic apparatus, and a second mode where the jog shuttle is used in controlling a menu settings for the electronic apparatus, the display command or the moving command corresponding to the first control or the second control may be recognized in the second mode.

The electronic apparatus may switch between the first mode and the second mode in accordance with kinds of content being displayed on the display.

The electronic apparatus may be controlled to operate in the second mode if the first control is performed.

In accordance with yet another exemplary embodiment, there is provided a remote controller comprising: a jog shuttle configured to provide first control of moving a control knob along a plate surface of the remote controller and second control of turning the control knob; and a controller configured to transmit, to an electronic apparatus, a display command of displaying a menu screen for setting the electronic apparatus on a display of the electronic apparatus as one of the first control and the second control is performed, and transmit, to the electronic apparatus, a moving command of moving a cursor pointing one of menus displayed on the menu screen as the other one of the first control and the second control is performed.

The display command may correspond to the first control, and the moving command may correspond to the second control.

The jog shuttle may provide third control of pressing the control knob toward the plate surface of the remote controller, and the controller may transmit, to the electronic apparatus, a selection command of selecting the menu pointed by the cursor as the third control is performed.

The remote controller may further comprise a switch for switching between a first mode where the jog shuttle is used in controlling an operation of the electronic apparatus and a second mode where the jog shuttle is used in controlling a menu settings of the electronic apparatus.

The remote controller may further comprise an electric generator configured to generate electricity based on displacement of the control knob when at least one of the first control, the second control and the third control is performed with respect to the jog shuttle.

The remote controller may further comprise a charger configured to charge a rechargeable battery, which supplies power needed for operations, with the electricity generated by the electric generator.

Accordingly, an aspect of one or more exemplary embodiments may provide a remote controller with a jog shuttle, which is more convenient for a user since the jog shuttle is utilized for other purposes as well as controlling operations of an electronic apparatus.

Another aspect is to provide a remote controller with a jog shuttle, in which power is replenished by itself, and therefore there are no needs of replacing a battery and there are no insufficient-charging problems in a photovoltaic system.

### BRIEF DESCRIPTION OF THE DRAWINGS

The above and/or the aspects will become apparent and more readily appreciated from the following description of exemplary embodiments, taken in conjunction with the accompanying drawings, in which:

FIG. 1 is a view illustrating a remote controller according to an exemplary embodiment;

FIG. 2 is a partially enlarged cross-section view showing a structure of a jog shuttle in FIG. 1 according to an exemplary embodiment;

FIG. 3 is a view illustrating a turning control and a moving control for the jog shuttle according to an exemplary embodiment;

FIG. 4 is a view illustrating a pressing control for the jog shuttle according to an exemplary embodiment;

FIG. 5 is a block diagram of a remote controller according to an exemplary embodiment;

FIG. 6 is a control flowchart in the remote controller of FIG. 5 according to an exemplary embodiment;

FIG. 7 is a detailed control flowchart of the operation S400 in FIG. 6 according to an exemplary embodiment;

FIG. 8 is a view showing that the jog shuttle is controlled to move rightward according to an exemplary embodiment;

FIG. 9 is a view illustrating a screen displayed as the jog shuttle is controlled as shown in FIG. 8 according to an exemplary embodiment;

FIG. 10 is a view showing that the jog shuttle is controlled to move upward according to an exemplary embodiment;

FIG. 11 is a view illustrating a screen displayed as the jog shuttle is controlled as shown in FIG. 10 according to an exemplary embodiment;

FIG. 12 is a view illustrating that the jog shuttle is controlled to be turned according to an exemplary embodiment;

FIG. 13 is a view illustrating a screen displayed as the jog shuttle is controlled as shown in FIG. 11 according to an exemplary embodiment;

FIG. 14 is a block diagram of an electronic apparatus to be controlled by a remote controller according to another exemplary embodiment; and

FIG. 15 is a control flowchart in the electronic apparatus of FIG. 14 according to an exemplary embodiment.

### DETAILED DESCRIPTION OF EXEMPLARY EMBODIMENTS

Below, exemplary embodiments will be described in more detail with reference to accompanying drawings. In the following descriptions, details of a general remote controller and a general electronic apparatus, which are not directly related to the present inventive concept, will be omitted.

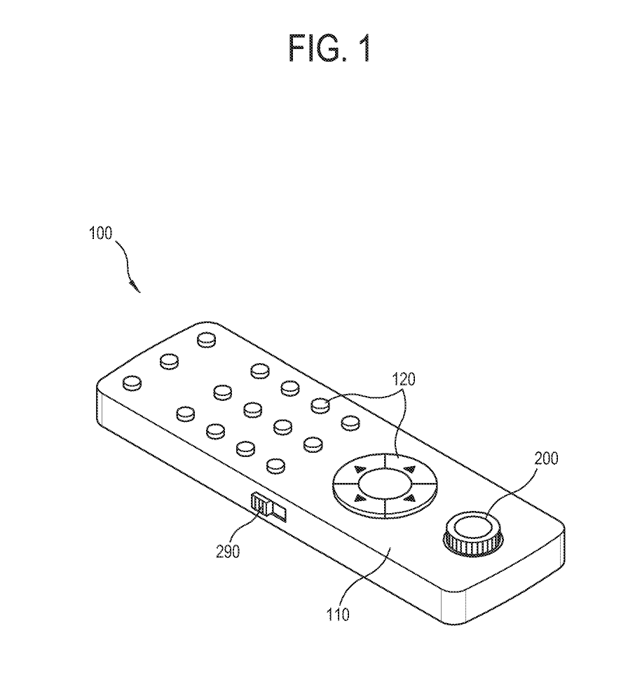

FIG. 1 illustrates an example of a remote controller according to an exemplary embodiment. The remote controller 100 includes various control button 120 and a jog shuttle 200. The jog shuttle 200 is manufactured in the form of a rotary knob protruding from a plate surface 110 of the remote controller 100.

The remote controller 100 includes a switchover switch 290 placed at a lateral side and used in switching over modes, details of which will be described later. The switchover switch 290 is manufactured in the form of a sliding switch controlled to slide and change in position, but not limited thereto. Alternatively, the switchover switch 290 may be provided as not a separate switch but one of the control buttons 120. Further, the switchover switch 290 may be achieved by simultaneously pressing two or more buttons of the control buttons 120.

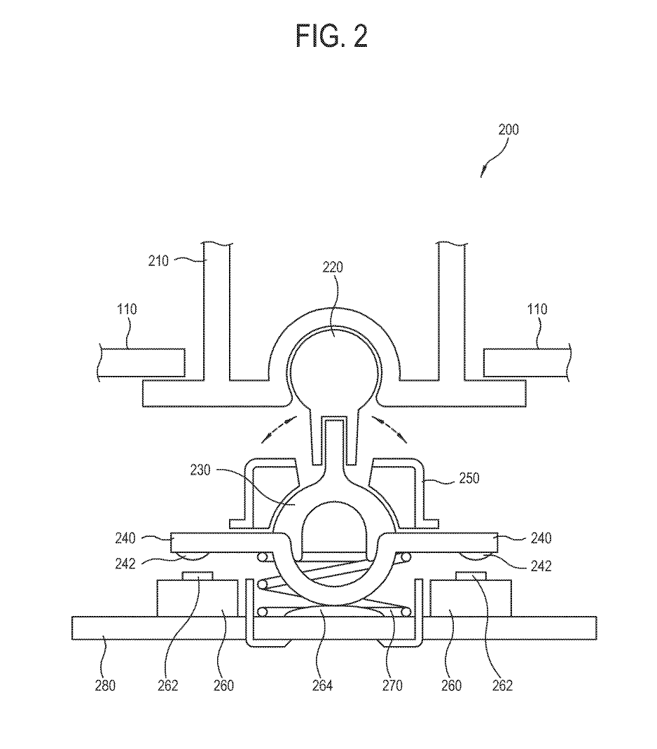

FIG. 2 is a partially enlarged cross-section view of showing a structure of a jog shuttle in FIG. 1 according to an exemplary embodiment. The jog shuttle 200 according to an exemplary embodiment has a mechanical structure for a moving control and a pressing control as well as a turning control. FIG. 2 shows an example of the jog shuttle 200 having such a mechanical structure, and the mechanical structure of the jog shuttle 200 according to an exemplary embodiment is not limited to the example shown in FIG. 2.

As shown in FIG. 2, the jog shuttle 200 includes a control knob 210 provided on the plate surface 110 of the remote controller 100. Under the control knob 210, a first joint ball 220 shaped like a ball is placed. The first joint ball 220 is connected to a support member 240 through a second joint ball 230. The second joint ball 230 is pivotally guided by the guide 250 at a fixed position. The support member 240 is supported on a printed circuit board (PCB) 280, and the PCB 280 includes a connection member 260 formed with a contact point 262. The support member 240 includes a contact point 242 that comes into contact with and separates from the contact point 262 of the connection member 260. Further, the support member 240 is supported by a spring 270 and elastically urged upward. In addition, a switch 264 is provided under the support member 240.

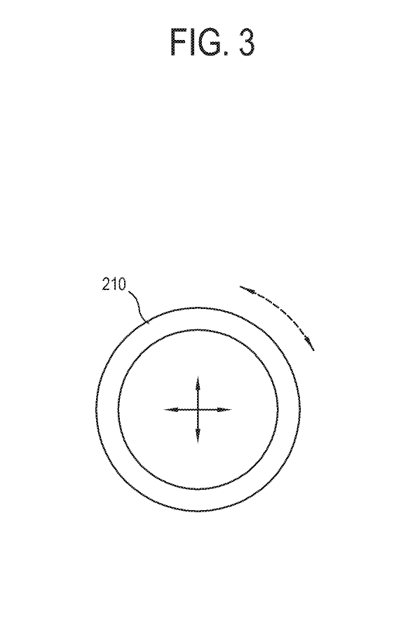

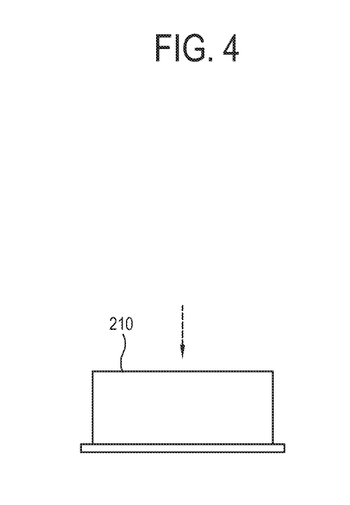

With this structure, the control knob 210 makes it possible to do a turning control based on the ball shape of the first joint ball 220, a moving control in a direction parallel with the plate surface 110, and a pressing control in a direction perpendicular to the plate surface 110. FIG. 3 is a view for explaining the turning control and the moving control for the jog shuttle according to an exemplary embodiment, and FIG. 4 is a view for explaining the pressing control for the jog shuttle according to an exemplary embodiment.

The turning control refers to an operation of turning the control knob 210 in clockwise or counterclockwise directions as shown in a curved arrow of FIG. 3. During the turning control, a sensor (not shown) separately provided in the structure of FIG. 2 senses this operation so that the remote controller 100 can recognize the turning control.

The moving control refers to an operation of moving the control knob 210 in up and down directions and left and right directions as shown in FIG. 3. During the moving control of the control knob 210, the first joint ball 220 and the second joint ball 230 are inclined to tilt the plate surface of the support member 240 so that the two contact points 242 and 262 can come into contact with each other, thereby making the remote controller 100 recognize the moving control and moving direction.

The pressing control refers to an operation of pressing the control knob 210 in a direction as shown in a downward arrow of FIG. 4. During the pressing control of the control knob 210, the support member 240 moves down against the elasticity of the spring 270 so that the switch 264 can be pressed, thereby making the remote controller 100 recognize the pressing control.

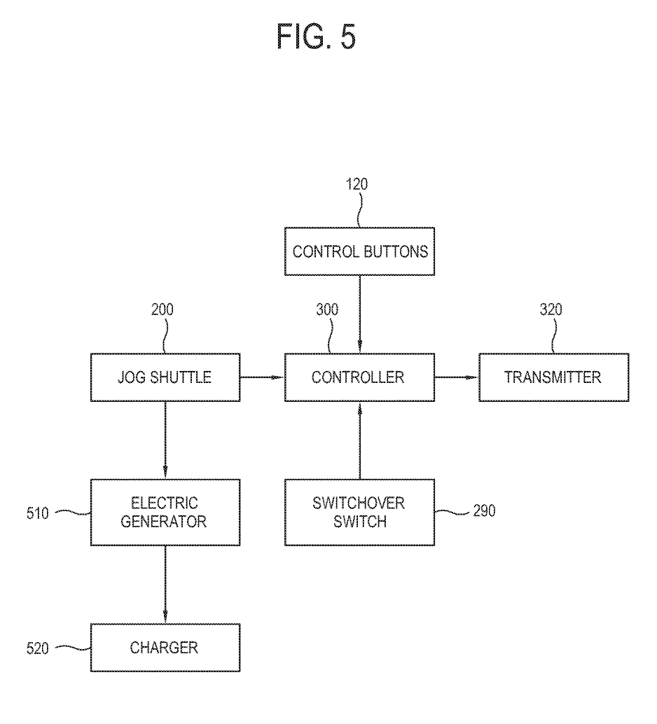

FIG. 5 is a block diagram of a remote controller according to an exemplary embodiment.

The remote controller 100 includes a controller 300, the control button 120, the switchover switch 290, the jog shuttle 200, a transmitter 320, an electric generator 510, and a charger 520. The control button 120, the switchover switch 290 and the jog shuttle 200 have analogous structure as described above with reference to FIG. 1 and FIG. 2, according to an exemplary embodiment.

The controller 300 generates a control command in accordance with controls of the jog shuttle 200, the control button 120 and the switchover switch 290. The transmitter 320 is typically provided as an infrared transmitter or the like to transmit a control command generated by the controller 300 to the electronic apparatus.

The electric generator 510 generates power using kinetic energy corresponding to operations of the control knob 210 in the jog shuttle 200. For example, displacement is caused by position movement or turning movement during the moving control, the turning control and the pressing control of the control knob 210, and therefore the electric generator 510 generates electricity based on the movement. As a typical example of the electric generator 510, there is an electromagnetic induction electric generator that includes a coil and a magnet. Besides, a triboelectric electric generator may be used. The structure of the electric generator 510 has been publicly known, and thus detailed descriptions thereof will be omitted.

The charger 520 charges a rechargeable battery provided in the remote controller 100 with electricity generated by the electric generator 510. Therefore, according to an exemplary embodiment, the rechargeable battery of the remote controller 100 is charged with the electricity generated whenever a user controls the control knob 210 of the jog shuttle 200. Accordingly, there are no needs of replacing the battery, and the rechargeable battery is more sufficiently charged than that charged using photovoltaic system.

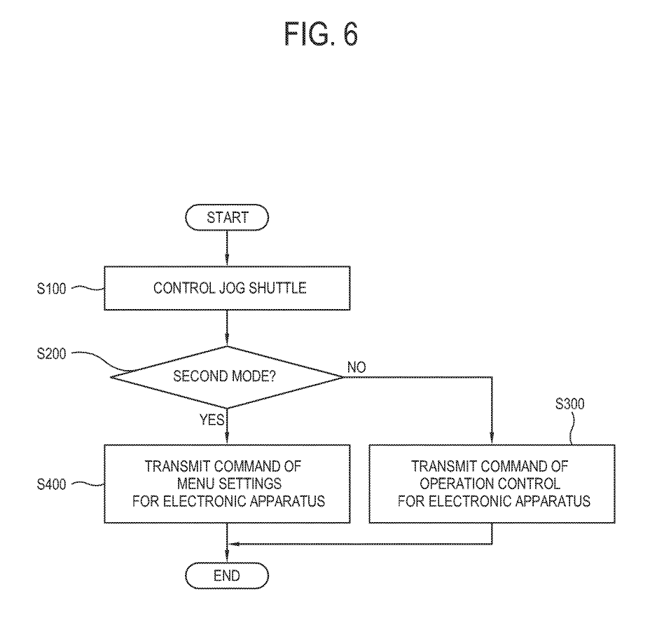

FIG. 6 is a control flowchart in the remote controller of FIG. 5 according to an exemplary embodiment.

The remote controller 100 according to an exemplary embodiment has two operation modes. A first mode refers to a mode where the jog shuttle 200 is used in controlling an operation state of an electronic apparatus, and a second mode refers to a mode where the jog shuttle 200 is used in controlling menu setting of the electronic apparatus. Switching between these two modes is achieved when a user controls the switchover switch 290.

When a user controls the jog shuttle 200 (S100), the controller 300 of the remote controller 100 determines whether a current operation mode is the second mode before performing an operation corresponding to the control of the jog shuttle 200 (S200). If the current operation mode is not the second mode but the first mode, the controller 300 determines that the control for the jog shuttle 200 is to control the operations of the electronic apparatus, and transmits a command for an operation control to the electronic apparatus through the transmitter 320 (S300). Here, the operation control of the electronic apparatus includes a control for typical original operations of the jog shuttle 200, such as a playback-speed increasing/decreasing operation, a rewinding operation, a volume control operation, etc. of an image being currently displayed.

If it is determined in the operation S200 that the current operation mode is set to the second mode, the controller 300 determines the control for the jog shuttle 200 is a control for the menu settings of the electronic apparatus, and transmits a command for the menu settings to the electronic apparatus through the transmitter 320 (S400). Here, the command for the menu settings of the electronic apparatus refers to a control for the electronic apparatus regardless of a control for an image being currently displayed.

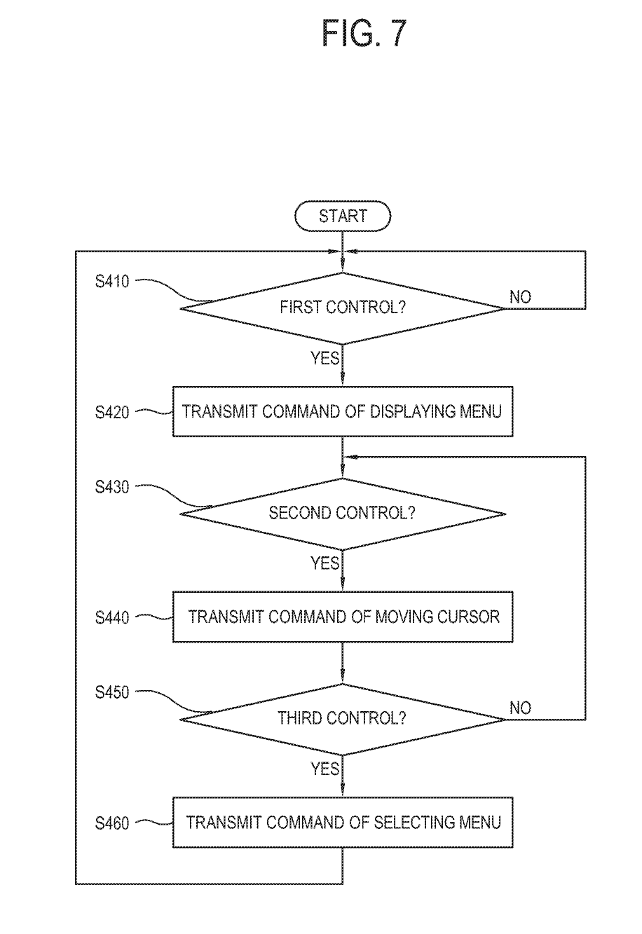

FIG. 7 is a detailed control flowchart of the operation S400 in FIG. 6 according to an exemplary embodiment. In FIG. 7, the moving control of moving the control knob 210 in a direction parallel with the plate surface 110 of the remote controller 100 is called a first control, the turning control of turning the control knob 210 is called a second control, and the pressing control of pressing the control knob 210 toward the plate surface 110 of the remote controller 100 is called a third control. The first control is a control for issuing a command to display a menu screen for setting the electronic apparatus on a display of the electronic apparatus, the second control is a control for issuing a command to move a cursor of pointing one of menus displayed on the menu screen, and the third control is a control for issuing a command to select a menu pointed by the cursor.

First, the controller 300 determines whether the first control is performed (S410). If the first control is performed, the controller 300 transmits the command of displaying the menu to the electronic apparatus through the transmitter 320 (S420).

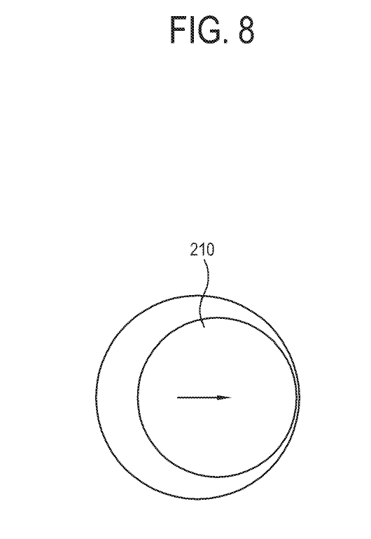

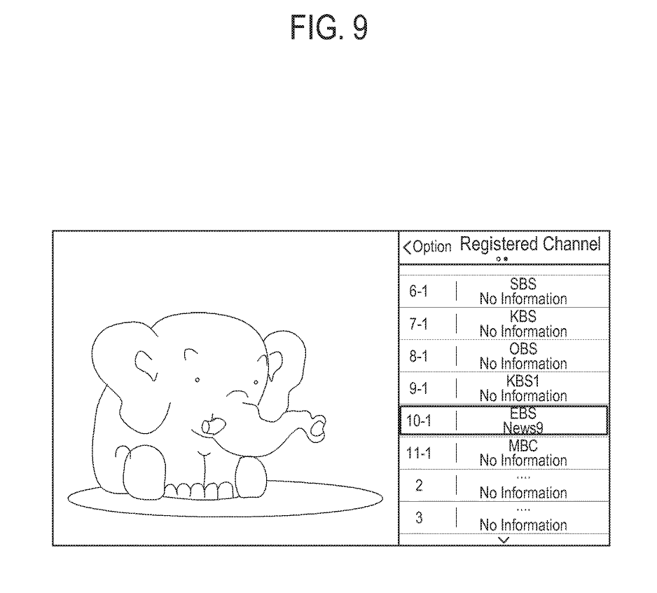

FIG. 8 is a view of showing that the control knob 210 is controlled to move rightward according to an exemplary embodiment, and FIG. 9 illustrates an example of a screen displayed as the control knob 210 is controlled as shown in FIG. 8 according to an exemplary embodiment, in which a TV will be illustrated as an example of the electronic apparatus. If the control knob 210 is controlled to move rightward as shown in FIG. 8, the electronic apparatus displays a menu screen corresponding to the rightward moving control in response to the command from the remote controller 100. FIG. 9 shows that a list of registered channels previously set by a user with respect to a TV is displayed as an example of the menu screen.

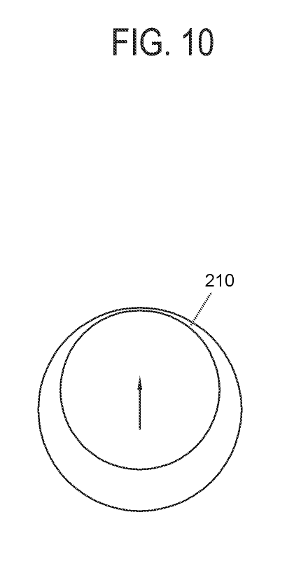

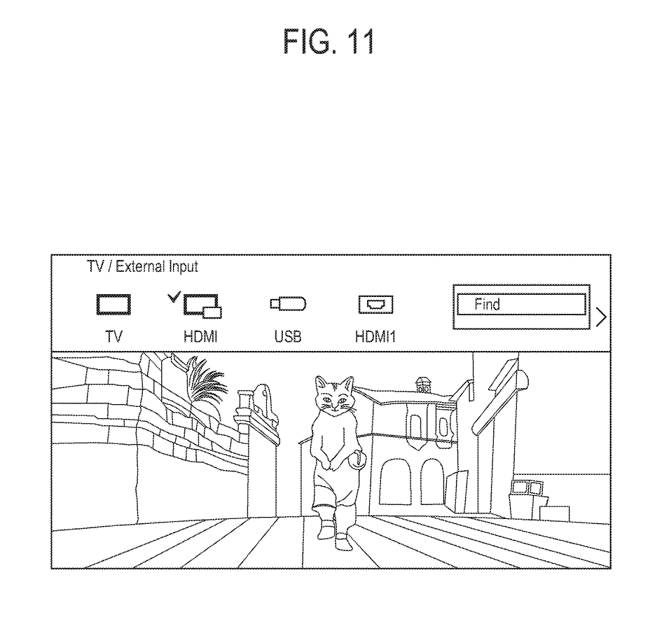

FIG. 10 is a view of showing that the control knob 210 is controlled to move upward according to an exemplary embodiment, and FIG. 11 illustrates an example of a screen displayed as the control knob 210 is controlled as shown in FIG. 10, according to an exemplary embodiment. If the control knob 210 is controlled to move upward as shown in FIG. 10, the electronic apparatus displays a menu screen corresponding to the upward moving control in response to the command from the remote controller 100. FIG. 11 shows that a list of selectable items such as a universal serial bus (USB) recording medium, a high definition multimedia interface (HDMI) video input, etc. with respect to external inputs of the TV is displayed as an example of the menu screen.

Like this, according to an exemplary embodiment, the command of displaying the menu screen corresponds to the first control, i.e. the moving control of the control knob 210, and includes a plurality of display commands so that the kind of menu screens can be varied depending on the directions of the moving control. It will be appreciated that different display commands are assigned to the leftward moving control and the downward moving control.

If the menu screen is displayed by the first control, the controller 300 determines whether the second control is performed (S430). If the second control is performed, the controller 300 transmits a command of moving the cursor within the menu screen being currently displayed to the electronic apparatus through the transmitter 320 (S440). Since the second control is the turning control, clockwise turning may correspond to a command of moving the cursor rightward or downward and counterclockwise turning may correspond to a command of moving the cursor leftward or upward. If the list is arranged up and down directions on the menu screen as shown in FIG. 9, the turning control is set to a command of moving the cursor upward or downward in accordance with turning directions. If the list is arranged left and right directions on the menu screen as shown in FIG. 11, the turning control is set to a command of moving the cursor leftward or rightward in accordance with turning directions.

In the state that the cursor is moved to a specific menu on the menu screen in the second control, the controller 300 determines whether the third control is performed (S450). If the third control is performed, the controller 300 transmits a command of selecting a menu currently pointed by the cursor on the menu screen to the electronic apparatus through the transmitter 320 (S460). Thus, the electronic apparatus carries out a function of the menu selected by a user. For example, if the pressing control of the control knob 210 is performed in the state of FIG. 9, a current channel of the TV is changed into a channel of ‘10-1’. If the pressing control of the control knob 210 is performed in the state of FIG. 11, a function of searching peripheral devices is performed to receive a current TV video signal.

In the exemplary embodiments shown in FIG. 7 to FIG. 11, the display command corresponds to the first control for the moving control of the control knob 210, and the moving command corresponds to the second control for the turning control of the control knob 210. Alternatively, the display command may correspond to the second control for the turning control of the control knob 210, and the moving command may correspond to the first control for the moving control of the control knob 210.

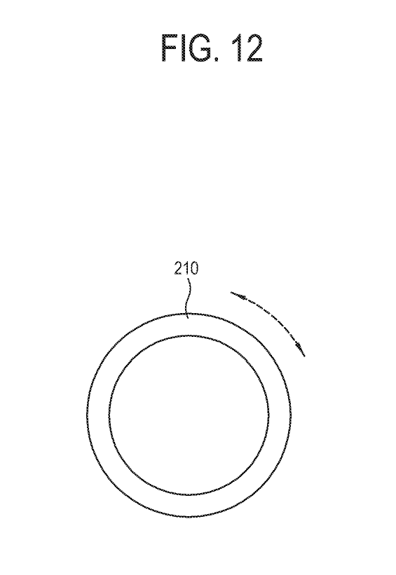

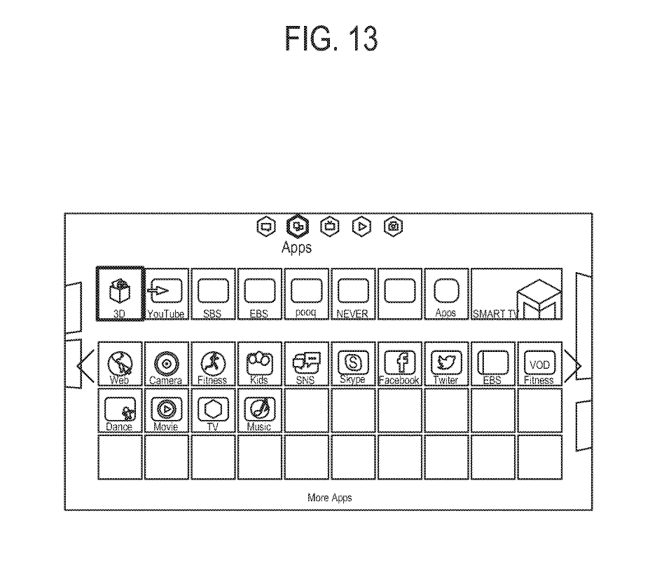

FIGS. 12 and 13 illustrate such examples, in which FIG. 12 is a view of showing that the control knob 210 is controlled to be turned, according to an exemplary embodiment, and FIG. 13 illustrates an example of a screen displayed as the control knob 210 is controlled to be turned as shown in FIG. 11, according to an exemplary embodiment. If a user turns the control knob 210 as shown in FIG. 12, a menu screen is displayed as shown in FIG. 13. In FIG. 13, the menu screen is configured to display various applications (Apps) supported in a smart TV. On this menu screen, a user moves the control knob 210 to move the cursor up, down, left and right, and presses the control knob 210 to select a specific icon after moving the cursor.

In this exemplary embodiment, different menu screens may be previously assigned to different directions of the turning control. For example, the menu screen of FIG. 13 may be assigned to the clockwise turning control, and another menu screen may be assigned to the counterclockwise turning control.

This case may be useful when the menus selectable on the menu screen are arranged in up, down, left and right directions as shown in FIG. 13 and thus the cursor needs to move in up, down, left and right directions.

Further, exemplary embodiments of FIGS. 7 to 11 and an exemplary embodiment of FIG. 13 may be combined with each other. For example, an initial control with regard to the first control and the second control is regarded as a command of displaying the menu screen, and the next controls are regarded as commands of moving the cursor. In this manner, it is possible to respectively assign different menu screens to a total of six controls such as up, down, left and right moving commands and clockwise/counterclockwise turning commands.

In the foregoing exemplary embodiments, the operation of FIG. 7 presupposes the operation of FIG. 6. That is, as described with reference to FIG. 6, in the foregoing exemplary embodiments, the menu settings or the operation control of the electronic apparatus is selectively performed in accordance with whether the operation mode of the remote controller 100 is set to the second mode for transmitting a command for setting the menu of the electronic apparatus.

According to an alternative exemplary embodiment, the operation mode of the remote controller 100 may be automatically switched over to the second mode in accordance with control methods of the control knob 210. This exemplary embodiment is possible since only some control methods are generally used when the control knob 210 is used for controlling the typical operations of the electronic apparatus.

If only the typical functions of the jog shuttle 200 are needed, i.e. if the control knob 210 is used to directly control an image currently displayed on the TV, only the turning control of the control knob 210 may be needed for increasing/decreasing the playback speed or controlling volume up/down, and the moving control or the pressing control may be unnecessary. Therefore, if the control knob 210 is moved (i.e. the first control) or pressed (i.e. the third control) even though the current operation mode of the remote controller 100 is the first mode, the remote controller 100 receives it as a command for changing the operation mode and thus switches over to the second mode or receives it as a command for directly displaying the menu screen without separately changing the operation mode.

In this manner, a user does not have to do an additional operation for changing the mode. In this case, the switchover switch 290 is not necessary in the remote controller 100.

In the foregoing exemplary embodiments, the operation mode is set with regard to the remote controller 100, or the operation mode is automatically switched over. Alternatively, such operations may be performed by not the remote controller 100 but the electronic apparatus. In this case, there are no needs of changing software in the remote controller 100. Accordingly, instead of the remote controller 100 specially manufactured according to an exemplary embodiment, the existing remote controller 100 is useful by changing software of the electronic apparatus.

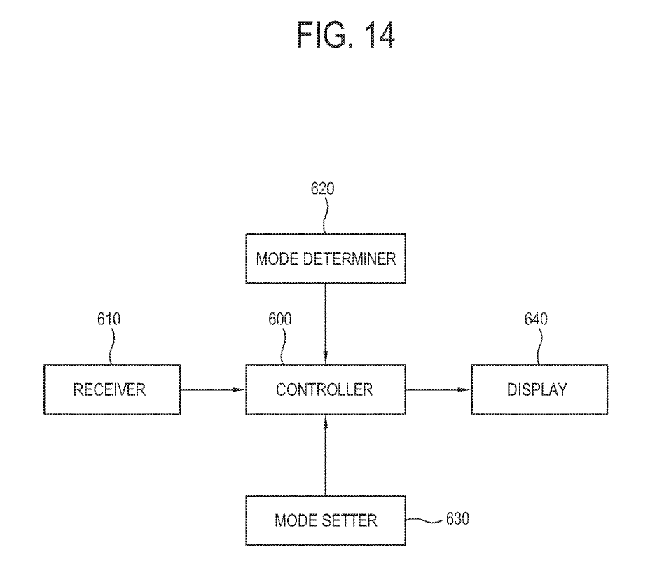

FIG. 14 is a block diagram of an electronic apparatus to be controlled by a remote controller according to another exemplary embodiment.

The electronic apparatus includes a controller 600, a receiver 610, a mode determiner 620, a mode setter 630 and a display 640. The receiver 610 receives a signal from the remote controller 100. For example, the receiver 610 may be achieved by an infrared receiver or the like. The controller 600 controls the electronic apparatus to carry out a command in response to a signal received in the receiver 610. The display 640 displays a menu screen to be controlled by the controller 600 or an image currently played back in the electronic apparatus.

The mode setter 630 sets an operation mode into a first mode or a second mode in response to a user's control using the jog shuttle 200 of the remote controller 100 so as to carry out a command received in the electronic apparatus. Here, the first mode and the second mode are the same as the operation modes of the foregoing remote controller 100, in which the first mode refers to a mode where a signal caused by the jog shuttle 200 of the remote controller 100 is recognized as a command for controlling an operation of the electronic apparatus, and the second mode refers to a mode where the signal is recognized as a command for controlling menu settings of the electronic apparatus. Therefore, like the foregoing description that a user can manually set the first mode and the second mode through the switchover switch 290 of the remote controller 100, the electronic apparatus may be also freely set to the first mode and the second by a user through the mode setter 630.

The mode determiner 620 automatically switches the operation mode of the electronic apparatus from the first mode over to the second mode when the jog shuttle 200 of the remote controller 100 is controlled. In other words, the operation mode of the electronic apparatus is automatically switched over to the second mode in accordance with control patterns when the control knob 210 is controlled. Thus, switching of the operation mode by the mode determiner 620 is the same as automatic switching of the operation mode in the remote controller 100, but different in that the switching of the operation mode is performed in the electronic apparatus.

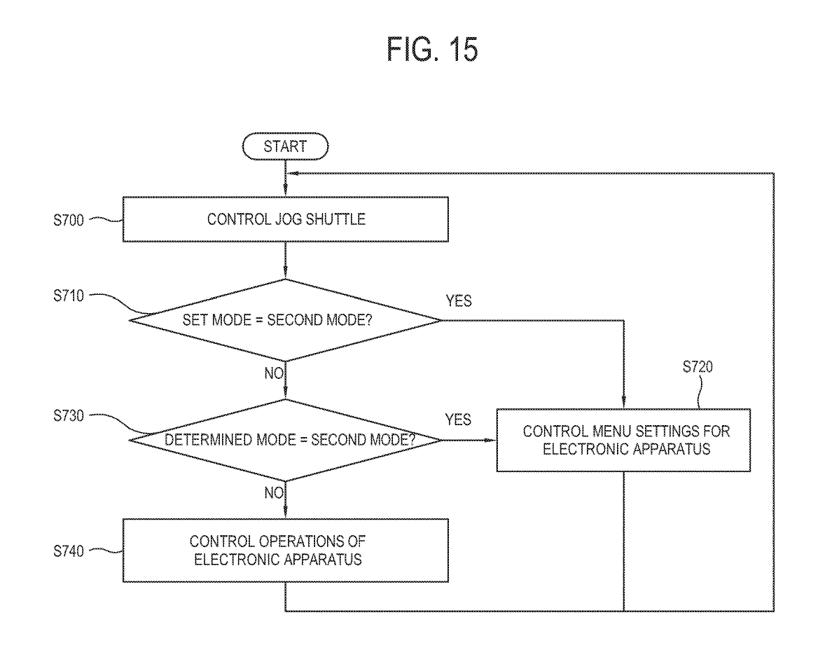

FIG. 15 is a control flowchart in the electronic apparatus of FIG. 14, according to an exemplary embodiment.

If a user controls the control knob 210 provided in the jog shuttle 200 of the remote controller 100 (S700), the controller 600 of the electronic apparatus determines whether the operation mode currently set by the mode setter 630 is the second mode (S710). If it is determined that the operation mode is the second mode, the electronic apparatus recognizes a command issued by the control of the control knob 210 as a command for the menu settings of the electronic apparatus and performs control for the menu settings (S720). Detailed control of the operation S720 is the same as those described in the exemplary embodiment with reference to FIG. 7 and its alternative embodiment.

If it is determined in the operation S710 that the preset operation mode is the first mode, the electronic apparatus determines the operation mode through the mode determiner 620 (S730). In other words, like the alternative embodiment of the remote controller 100, if the control of the control knob 210 is not related to a command of controlling an image being currently displayed on the TV, e.g. the moving control or pressing control of the control knob 210, the mode determiner 620 recognizes it as a command for switching over to the second mode or a command only under the second mode. Therefore, the controller 600 of the electronic apparatus controls the menu settings of the electronic apparatus in the second mode of the operation S720. If the mode determiner 620 determines that a command is not in the second mode, the electronic apparatus controls its typical operations (S740).

The foregoing various alternatives described for the remote controller 100 are also directly applicable to this exemplary embodiment for the electronic apparatus, and become various exemplary embodiments of the electronic apparatus. In this regard, repetitive descriptions will be avoided.

By the way, automatic switching between the first mode and the second mode of the mode determiner 620 may be achieved in accordance with not the control patterns of the control knob 210 as described above, but the kinds of content being currently displayed on the electronic apparatus.

For example, if an image being currently played back is an image stored in a USB memory connected to the TV, the mode determiner 620 recognizes the control of the control knob 210 as a command of increasing/decreasing playback speed of the image. On the other hand, if an image being currently played back is an image from cable broadcasting or airwave broadcasting, the mode determiner 620 determines that the control of the jog shuttle 200 is not necessary and recognizes the control of the control knob 210 as a command of displaying the menu screen.

In this manner, the kind of content is taken into account. In case of content that needs the first mode, the control of the jog shuttle 200 is recognized as a command of directly controlling the content. On the other hand, in case of content that does not need the first mode or needs the first mode only under very limited conditions, the control of the jog shuttle 200 is recognized as a command of displaying the menu screen or a command of switching over to the second mode. Accordingly, the remote controller 100 is more convenient for a user.

As described above, the jog shuttle of the remote controller may be used in not only directly controlling a playback mode of an image being currently played back but also selecting various menus of the electronic apparatus to be controlled. Accordingly, the jog shuttle may be used in controlling various functions such as configuration settings of the electronic apparatus, etc. and thus the remote controller is more convenient for a user.

Further, there are no needs of replacing the battery or there are no inconvenience due to insufficient charging since the rechargeable battery of the remote controller is charged whenever the jog shuttle is controlled.

Although a few exemplary embodiments have been shown and described, it will be appreciated by those skilled in the art that changes may be made in these exemplary embodiments without departing from the principles and spirit of an inventive concept, the scope of which is defined in the appended claims and their equivalents.

What is claimed is:

1. A method of controlling a remote controller comprising:
receiving at least one of a first control and a second control from a jog shuttle of the remote controller, wherein the first control is moving a control knob of the jog shuttle along a plate surface of the remote controller and the second control is turning the control knob;
transmitting, to an electronic apparatus, a display command of displaying a setting menu screen for the electronic apparatus, on a display of the electronic apparatus, in response to the receiving one of the first control and the second control; and
transmitting, to the electronic apparatus, a moving command of moving a cursor pointing to one of menus displayed on the menu screen in response to the receiving the other one of the first control and the second control.

2. The method according to claim 1, wherein the display command corresponds to the first control and the moving command corresponds to the second control.

3. The method according to claim 1, further comprising:
transmitting, to the electronic apparatus, a selection command of selecting the menu pointed by the cursor in response to receiving a third control from the jog shuttle,
wherein the third control is pressing the control knob toward the plate surface of the remote controller.

4. The method according to claim 1, wherein the remote controller further comprises a switch for switching between a first mode in which the jog shuttle controls an operation of the electronic apparatus and a second mode in which the jog shuttle controls a menu settings of the electronic apparatus, and
wherein one of the display command and the moving command is transmitted in the second mode.

5. A method of controlling an electronic apparatus comprising:
detecting a display command, which is input in response to one of a first control and a second control, and displaying a setting menu screen for the electronic apparatus, on a display of the electronic apparatus; and
detecting a moving command, which is input in response to the other one of the first control and the second control, and moving a cursor pointing one of menus displayed on the menu screen,
wherein the first control is moving a control knob of a jog shuttle of a remote controller along a plate surface of the remote controller and the second control is turning the control knob.

6. The method according to claim 5, wherein the display command corresponds to the first control and the moving command corresponds to the second control.

7. The method according to claim 5,
further comprising detecting a selection command, which is input in response to a third control, and selecting the menu pointed by the cursor,
wherein the third control is pressing the control knob toward the plate surface of the remote controller.

8. The method according to claim 5, wherein the electronic apparatus has a first mode in which the jog shuttle controls an operation of the electronic apparatus, and a second mode in which the jog shuttle controls a menu settings of the electronic apparatus,
wherein one of the display command the moving command is detected in the second mode.

9. The method according to claim 8, further comprising switching the electronic apparatus between the first mode and the second mode based on types of content being displayed on the display.

10. The method according to claim 8, wherein, in response to the first control being performed on the jog shuttle, controlling the electronic apparatus to operate in the second mode.

11. A remote controller comprising:
a jog shuttle configured to provide a first control in which a control knob is moved along a plate surface of the remote controller and a second control in which the control knob is turned; and
a controller configured to transmit, to an electronic apparatus, a display command of displaying a setting menu screen for the electronic apparatus on a display of the electronic apparatus in response to one of the first control and the second control being performed, and transmit, to the electronic apparatus, a moving command of moving a cursor pointing to one of menus displayed on the menu screen in response to the other one of the first control and the second control being performed.

12. The remote controller according to claim 11, wherein the display command corresponds to the first control and the moving command corresponds to the second control.

13. The remote controller according to claim 11, wherein the jog shuttle is further configured to provide a third control in which the control knob is pressed toward the plate surface of the remote controller, and
wherein the controller transmit, to the electronic apparatus, a selection command of selecting the menu pointed by the cursor in response to the third control being performed.

14. The remote controller according to claim 11, further comprising a switch configured to switch between a first mode in which the jog shuttle controls an operation of the electronic apparatus and a second mode in which the jog shuttle controls a menu settings of the electronic apparatus.

15. The remote controller according to claim 13, further comprising an electric generator configured to generate electricity based on displacement of the control knob in response to at least one of the first control, the second control, and the third control being performed.

16. The remote controller according to claim 15, further comprising a charger configured to charge a rechargeable battery, which supplies power needed for operations, with the electricity generated by the electric generator.
